(19) United States
(12) Patent Application Publication
(10) Pub. No.: US 2015/0061246 A1
(43) Pub. Date: Mar. 5, 2015

(54) Mobile Work Platform

(71) Applicant: James K. Bullis, Sunnyvale, CA (US)

(72) Inventor: James K. Bullis, Sunnyvale, CA (US)

(21) Appl. No.: 13/987,836

(22) Filed: Sep. 5, 2013

(51) Int. Cl. B62D 29/04; B62D 63/02

(52) U.S. Cl. CPC B62D 29/043; B62D 63/02
USPC 280/32.5

(57) ABSTRACT

Here invented is a mobile vehicle that is a narrow work platform for work in narrow row spaces between crops planted in rows. The frame of this platform holds and allows operation of attached wheels but also provides a low floor surface from where a worker can access crops adjacent to the vehicle. Worker actions as needed to tend crops at various heights down to ground level are supported by this apparatus.

The low floor is configured to enable access to the adjacent ground level just beyond the track of the vehicle wheels. This involves floor openings with flexible surfaces that close such openings. The flexible surfaces also act as a soft edge of the floor to prevent serious crushing injury of workers, particularly in fall down situations.

This patent document contains material that is subject to copyright protection. Facsimile reproduction is allowed of the patent document or the patent disclosure as it appears in the Patent and Trademark Office patent file or records as allowed by US patent law, but otherwise all copyright rights are reserved.

### BACKGROUND OF THE INVENTION

1. Field of the Invention

This present invention relates to farm machinery.

2. Description of the Prior Art

There is currently much concern for agricultural productivity, given the expanding world population. This is further exacerbated by the practice of using feed grain crops for making motor vehicle fuel. It is paramount that we make the best possible use of agricultural resources. One way to do this is to greatly expand irrigation by distributing water on a continental basis. This enlargement of agricultural operations could lead to a need for far more agricultural workers. Hopefully, we can find a way to do this within a legal immigration framework. A good start could be based on a new kind of apparatus that would enhance productivity of workers and make the work into a more attractive activity.

Some kinds of agricultural work are hard, slow, and uncomfortable. It is difficult to find workers and pay them enough to get them to do such tasks. To improve this situation with a machine requires both better productivity and greater comfort of the worker. Productivity has to be better per worker in order to make the cost of the machine affordable. Worker comfort has to be provided to attract worker, but also to enable more effective and sustained performance of tasks. Cost of the machine has to be compatible with expectations for improved productivity. Perhaps of greatest importance is the need for energy efficient operation. The intent is that the wages payable would ultimately increase. Still more fundamental are requirements for worker safety.

Compared with most generally familiar vehicles, agricultural vehicles of the sort that would significantly assist farm workers have significantly different performance requirements, and some of these offer potential for unique new system solutions. The biggest of these is the fact that for manual work, unusually low speed is desirable. Another key difference is that the low seat that would enable workers to reach to the ground would mean that conventional notions of how to stabilize a vehicle are inapplicable; particularly, a wide wheel base is not needed. Furthermore, the low operator riding position means that stability need not be so absolute since a roll over event would not be particularly hazardous; as we would normally think of such events for farm tractors. A design freedom is the fact that the overall length of a vehicle oriented toward row crop work can be quite large, enabling a vehicle and various ancillary equipment configured in a narrow but long train.

We look at the historical background for apparatus of this sort in the vast field of agricultural vehicles. Very little is found in the way of simple machines to enable hand work in the fields. Rather, the tendency seems to be to develop tractor based solutions or tractor like systems. Tractors make it possible for some kinds of crops to automate the work and to provide very comfortable cab conditions. For some types of crops this leads to very successful operations utilizing ever larger tractors and harvesters of many types. However, the present need seems to call for different approaches. In many situations, the needed work can simply can not be done from a large vehicle because of the need for hand work close to the ground or for workers to be in positions relative to growing crops that would be awkward from large vehicles. Large vehicles are often not desirable because the crops themselves interfere with access by such vehicles, and unfortunately, this can lead to farming methods where crop spacing does not make the best possible use of land resources, simply because land must be reserved to allow for the vehicle to pass.

U.S. Pat. No. 3,589,744 Hansen 1971 illustrates an apparatus intended to function as an aid to workers. This seems well suited for row crop work.

Less satisfactory is a situation where the vehicle prevents crop spacing that would make the best use of land resources such as shown in U.S. Pat. No. 3,546,856 Hiyama 1970, FIG. 2. Somewhat better, but still intrusive is the apparatus of U.S. Pat. No. 4,250,700 Horn et al. 1981. A farming system where it is desirable to enable both the worker and vehicle to pass under growing crop vines as illustrated by the U.S. Pat. No. 3,546,856 Hiyama 1970, FIG. 1 and U.S. Pat. No. 5,423,166 Scott 1995, thus showing the disadvantages of vehicles of the size range usually found in farm vehicles. Further, U.S. Pat. No. 5,423,166 Scott 1995 illustrates the intrusiveness of both grape acquisition machinery and the associated trailer by which harvested grapes are collected.

Many vehicle configurations have been invented with these purposes in mind. Many tend to be constrained to conventional ways of thinking about tractors, farm vehicles that already exist, and about automobiles. Though the invention U.S. Pat. No. 3,589,744 Hansen 1971 seems to be useful, it is complicated. Conventional wheels with balloon type tires mounted are arranged in a three point stabilizing form, generally like many farm tractors, but also harking back to the three wheeled Morgan roadster of long ago. This is adapted to working on low growing crops with over-arching structure that allows passing over crop rows, but all this leads to complicated equipment, when simplicity is needed to allow inexpensive construction. Still this invention by Hansen is successful in providing a low seat for a worker that enables low crop access, all the way to ground level. Hansen shows one wheel that is relatively large which would help hold down drag when traversing over soft earth, but this of course does not indicate an attempt to use this for stability.

Continuous track vehicles serve to enable operation on soft dirt. A wide variation of such a track would offer lateral stability to prevent roll over, should it be used for that purpose, and the included wheels with the track could provide a wide wheel base if needed. The wide range of use of tracked vehicles in agriculture is represented by U.S. Pat. No. 1,376,649 Schneider 1921 and U.S. Pat. No. 4,683,969 Littau 1987. U.S. Pat. No. 7,543,664 Nelson 2009 shows a rubber version, and though this is not indicated, this could be adapted to provide stability as well as load spreading benefits. Generally, vehicles using tracked wheel systems arrange for the tracks to act in widely spaced pairs to provide stability. Rubber forms of tracked systems are used in snow-mobiles, where the track acts to provide stabilization, though generally in combination with ski-like surfaces.

Comparing again to U.S. Pat. No. 3,589,744 Hansen 1971, a simpler vehicle would be the recumbent bicycle as illustrated with a sidecar in U.S. Pat. No. 6,565,106 Lopez 2003. With or without a motor or engine this at least shows the basic simplicity needed. A tricycle form of this recumbent bicycle is an obvious variation that can be occasionally seen in use, but this would be still quite useless for the present purpose given that these wheels, though large in diameter, are narrow such that they would sink in soft dirt and cause much resistance to vehicle movement. The obvious tricycle form often includes wide, laterally spaced wheel sets; significantly wider than what would be desired for carrying a worker between narrowly spaced rows.

A very simple aid to workers would be the wheeled stool of U.S. Pat. No. 3,614,120 Cicero 1971 where a seat is provided with a seat back at a slanted position that would make low work more comfortable. This invention shows wide wheels but these are shown as they are mostly for convenience, as they are indicated to be typical rubber balloon tires. Stability for this “Chair Cycle” depends on the use of the legs and feet of the worker, not a lot differently from the way one legged milk stools were stabilized by the user.

One impediment to progress is the widely used rubber, balloon, tractor tire such as indicated in U.S. Pat. No. 3,589,744 Hansen 1971. This works fine where there is a pair of widely spaced wheels that achieves stability, but by itself offers no resistance to rolling sidewise. But wide spacing is exactly what we are not looking for, in order to accomplish the present purposes for enabling more effective crop work.

Curiously, tractor tires of the 1920s utilized hard steel wheels with large spikes bolted to them, where these spikes were called lugs. Because the typical farmer used regular roadways to get tractors from field to field, these lugs caused much disruption of smooth road surfaces. All this went away with inflated rubber tires of the mentioned balloon type. Lugs might not matter to stability, and they could be advantageous in a low speed vehicle.

Searching for solid wheels that would improve stability with a narrow wheelbase turned up U.S. Pat. No. 1,210,056 Fairman 1916 where a narrow vehicle is fitted with hard wheels. This vehicle is questionable as to safety given the high seat position, and of course this configuration does not suggest any interest in enabling hand work on low crops. A tractor utilizing hard wheels configured of lateral slats overlaid with slanted gripping ridges is shown in U.S. Pat. No. 2,560,384 Crain 1951. Though far from the field of farm vehicles, a relevant solid drum wheel is shown in the baby carriage for use in soft dirt of U.S. Pat. No. 5,158,319 Norcia et al. 1992, though there is no low seat for farm work and no special stabilizing purpose involved other than that of conventional baby carriage wheels.

U.S. Pat. No. 6,752,228 Aoyama 2004 reminds us of a function of agricultural vehicles depending on existence of tow bar capabilities, but it also illustrates the difficulty that is encountered in making the seat position truly low. This particular invention is announced as one that enables a low profile operation.

Applicable prior art goes far beyond the limited discoveries resulting from searching the patent literature. However, it seems clear that there has not been satisfactory development work to support advances in agriculture practice that might be possible.

### SUMMARY OF THE INVENTION

Implementation and testing of a vehicle that provides a low seating position for a worker where the lateral dimension is small to enable fitting through narrow spaces such as narrowly spaced crop rows has proceeded. This work has shown the importance of a low vehicle floor as a work platform, but it also has shown that the floor needs to be cut back to a width less than that of the wheel track width. Safety concerns led to fashioning of panels that hinge to allow them to swing downward, but safety concerns remained as well as dissatisfaction with the hinging panel arrangement as a complicated mechanism.

The vehicle includes a frame with an attached wheel set and an attached seat for a worker that enables the worker to ride facing generally in the forward direction of travel. The entire vehicle is approximately 6 inches wider than the width of a seat for that seated worker. Within such narrow width confines, the wheel set is configured for both stability and efficiency in dirt.

The seat is carried down to near the level of a low floor from where a worker can access crops adjacent to the vehicle. With cut-outs in the floor, access is enabled down to ground level. However, the floor openings are closed with flexible material, generally of rubber-like material that provides an approximately flat floor surface except for when pressed downward or to the side. When thus pressed, the rubber-like material gives way, down to the ground surface, or inward to function as a soft edge of the floor.

### BRIEF DESCRIPTION OF THE DRAWINGS

FIG. 1 Agricultural vehicle as a work platform for use in field of row crops

FIG. 2 Work platform with floor cut-out with inserted closure surface adjacent to representative crop item

FIG. 3 Floor closure surface deflected downward to access plant to ground level

FIG. 4 Floor closure surface deflected inward to minimize injury to worker

### DETAILED DESCRIPTION

The simplest embodiment of this invention is first described, but as many applications of farm tractors are considered, the variations in form and ancillary equipment evolve significantly. All such applications would be expansions on the basic invented concept. Other applications hitherto not related to operation of farm tractors also have emerged, and others are expected. The intention here is to show the scope of the invention by mention of variations and adaptations.

The invention here was done based on generally known apparatus most of which was known prior to reference to the patent literature described in the background section previously included here. However, the background art clearly shows limited extension of industrial technology to the agricultural world to provide what could be important changes in agricultural practice. Thus that practice carries on, seemingly unaware that industrial approaches could minimize the difficulty and discomfort of the work, not to mention what such approaches could do to enhance productivity of both workers and land.

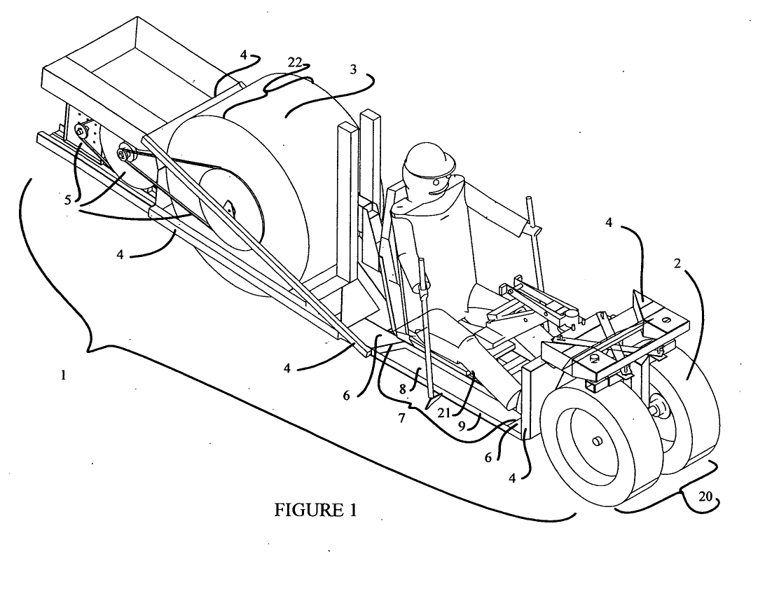

FIG. 1 shows an embodiment of the invented vehicle for utilization in row crop work as an example application. The discussion here is cursory with respect to general vehicle features, since the purpose here is to explain the particular features of the present invention. Further details are available in co-pending applications Ser. No. 13/199,968 Bullis 2011, Ser. No. 13/385,984 Bullis 2012 (abandoned due to response time error), Ser. No. 13/506,304 Bullis 2012, Ser. No. 13/506,181 Bullis 2012, and Ser. No. 13/385,924 Bullis2012 which are all here incorporated by reference.

Narrow vehicle 1 operates on soft surfaces is shown. Front 2 and rear 3 wheels are mounted to the frame 4 and representative apparatus indicating means for operating as a mobile vehicle 5 are shown at the rear. The general low floor 6 is the part of the frame 4 between front 2 and rear 3 wheels. A cut-out section 7 is indicated at the right side with closure surface 8 at floor level. Beyond cut-out parts, the low floor still extends to full vehicle width 20. A restraining border 9 of closure surface 8 is shown. The term “cut-out” is used descriptively to make the floor arrangement clear. Actual fabrication of the floor is done by shaping the steel pieces and welding them to achieve the shape shown. This implements a tongue configuration having a general effect of enabling clear access to crops to the side and above.

Width of vehicle 20, overall, is approximately 6 inches wider than the seat 21 for the placeholder worker. Track width 22 is approximately the same as vehicle width 20, except for allowance for frame 4 structure on each side, that being approximately 3 inches.

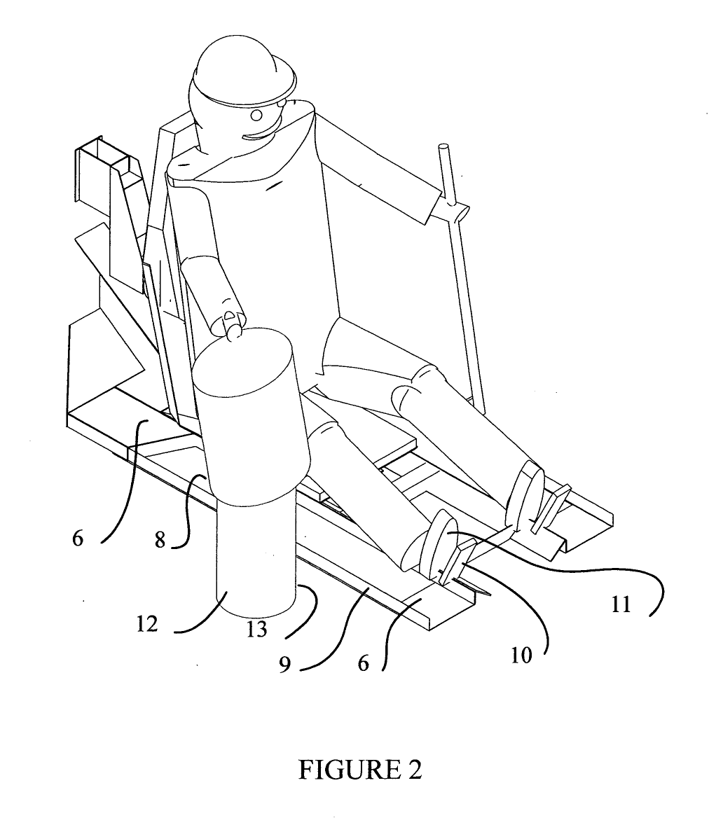

FIG. 2 is an expanded illustration of the invention. Pedal 10 shows working position of foot 11 of worker placeholder for mobility of vehicle. The low floor surface 6 is closed with rubber-like surface 8 with restraining border 9. Object 12 represents a plant to be tended, with its its ground level edge 13 next to the vehicle. Without action of the rubber like surface 8 and its edge 9 a worker is limited in ability to reach that ground level edge 13 where work access is needed.

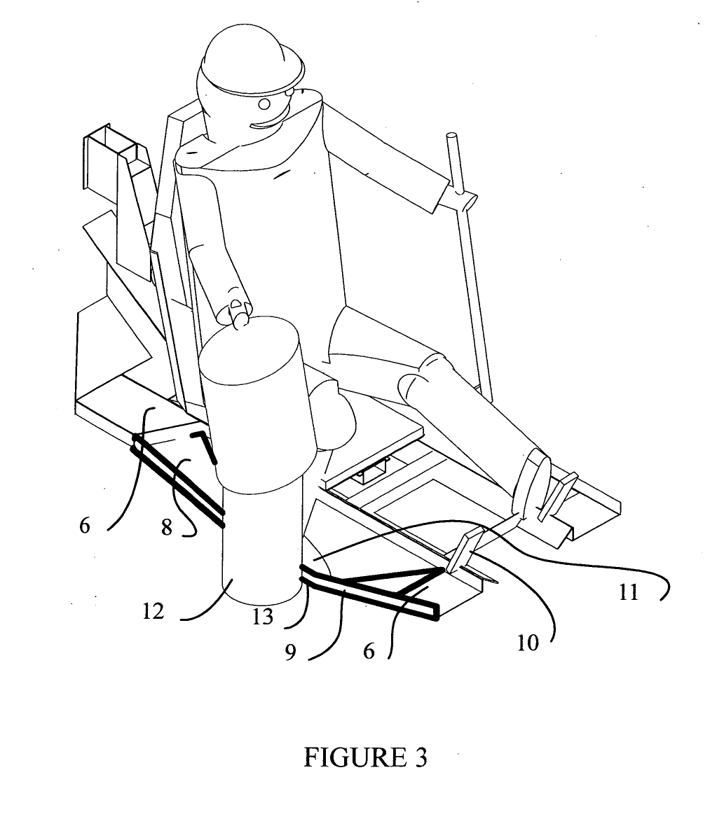

FIG. 3 shows shows lowered position of surface 8 and edge 9 under pressure at worker foot position 11. This enables clear access to inner edge of object 12 at ground level 13. Worker's foot position is still safe on the lowered surface 8, with slip preventing edge 9 functioning as intended.

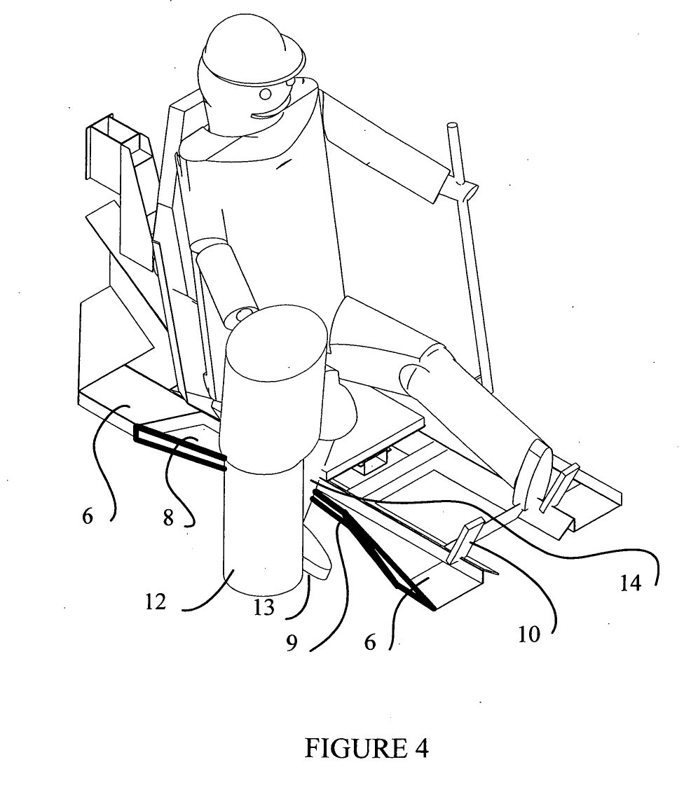

FIG. 4 represents a variety of disaster threatening situations, where worker leg is in position 14 to be injured by the vehicle floor 6 edge were such injury not prevented by the invention. In shown leg position 14 such leg would be crushed by a hard object 12 and the floor 6. Here the leg injury is prevented by absence of hard part of the floor 6, and closing insertion with the rubber-like surface 8 and edge 9 to allow inward flexing of the otherwise rigid floor 6.

Although the crushing situation is depicted here with the vehicle in upright position, it is a vehicle that must be capable of fall down without causing serious injury. The low and narrow tongue structure is effective in this regard since there is low chance that the worker would be crushed between the tongue and the ground. However, the invented rubber-like attachments are also important.

Rubber-like material is conveyor belt material which is rubber with fabric reinforcement. Any woven, flexible, but sturdy material would be satisfactory. Durability is needed to allow intermittent, but frequent, rubbing contact with the ground which is generally not entirely flat or smooth.

Frame 4 shown in FIG. 1 includes a narrow tongue structure which is also the main part of the low floor 6. This must be strong to rigidly link between wheels such that it is preferred that it be constructed of cold-rolled steel. Generally we operate at low speeds on soft ground, so the vehicle does not require spring action. This is not expected to be the case in all implementations, and in such cases actual flexing of the otherwise rigid frame shown would be part of the mechanism.

This description applies for various scaled sizes. However, the focus of development is on applications where a wheel track of 20 inch width and a vehicle width 20 of 26 inch would fit in a row space that comes about when plants, such as wine grape vines, are planted in rows in traditional 1 meter spacing on center. Most vineyards in North America are planted to enable conventional tractors that are far to wide for this; and even efforts to narrow the tractor, the wheel tracks down to 40 inches do not allow enough margin between actual plants. Thus, 40 inch spacing is anticipated as a big improvement in efficiency of land use.

The scope of the invention is to be defined by the appended claims.

I claim:

1. A mobile work platform that includes a frame with an attached front wheel and an attached rear wheel, where said platform includes means to carry a worker over the ground at working speeds,
where said platform includes a low floor that is adapted to clear the ground, where said floor is opened by a cut-out area that is flexibly closed by a material adapted to maintain a supportive, floor-like, surface, where said material enables flexibility of said floor-like surface under application of force.

2. A mobile work platform according to claim 1 that is adapted for operation in proximity to plants, where said application of force deforms said floor-like surface to enable access to said plants to ground level.

3. A mobile work platform according to claim 1 where said low floor is between said front wheel and said rear wheel, where cut-out parts leave a narrow structure that functions as a tongue that connects front and rear parts of said frame.

4. A mobile work platform according to claim 1 where said low floor incorporates a vertically thin structural capability that establishes a low frame that does not interfere with working access to objects above level of said floor.

5. A mobile work platform according to claim 1 where said material is sufficiently rigid to prevent dragging of worker body parts.

6. A mobile work platform according to claim 1 where said material is a rubber-like material that closes a cut-out area at an edge of said floor, thus providing an injury reducing soft edge on said floor.

7. A mobile work platform according to claim 1 where said material closes a cut-out area at an edge of said floor, with a border fixed to said material that prevents inadvertent sliding off said floor.

8. A mobile work platform that includes a frame with an attached front wheel and an attached rear wheel, where said platform includes means to carry a worker over the ground at working speeds that include a speed of 3 miles per hour,
where said platform includes a low floor that is adapted to clear the ground, where said floor is opened by a cut-out area that is flexibly closed by a rubber-like material adapted to maintain a supportive, floor-like, surface, where said material enables flexibility of said floor-like surface under application of force.

9. A mobile work platform according to claim 8 that is adapted for operation in proximity to plants, where said application of force deforms said floor-like surface to enable access to said plants to ground level.

10. A mobile work platform according to claim 8 where said low floor is between said front wheel and said rear wheel, where said cut-outs limit width of said floor such that the structural part is receded from the vehicle perimeter.

11. A mobile work platform according to claim 8 where said low floor incorporates a vertically thin structural capability that establishes a low frame that does not interfere with working access to objects above level of said floor.

12. A mobile work platform according to claim 8 where said material is sufficiently rigid to prevent dragging of worker body parts.

13. A mobile work platform according to claim 8 where said material is a rubber-like material that closes a cut-out area at an edge of said floor, thus providing an injury reducing soft edge on said floor.

14. A mobile work platform according to claim 8 where said material closes a cut-out area at an edge of said floor, with a border that is a upward bent edge of said material that prevents inadvertent sliding off said floor.

15. A mobile work platform that includes a frame with an attached front wheel and an attached rear wheel, where said platform includes means to carry a worker over the ground at working speeds,
where said platform includes a low floor that is adapted to clear the ground, where said floor extends to an outside of said platform, and where said floor is opened by a cut-out area that is flexibly closed by a rubber-like material adapted to maintain a supportive, floor-like, surface, where said material enables flexibility of said floor-like surface under application of force.

16. A mobile work platform according to claim 15 that is adapted for operation in proximity to plants, where said application of force deforms said floor-like surface to enable access to said plants to ground level.

17. A mobile work platform according to claim 15 where said low floor is between said front wheel and said rear wheel.

18. A mobile work platform according to claim 15 where said material is sufficiently rigid to prevent dragging of worker body parts.

19. A mobile work platform according to claim 15 where said material is a rubber-like material that closes a cut-out area at an edge of said floor, thus providing a soft edge on said floor.

20. A mobile work platform according to claim 15 where said material closes a cut-out area at an edge of said floor, with an edge fixed to said material that prevents inadvertent sliding off said floor.
